(19) United States
(12) Patent Application Publication
(10) Pub. No.: US 2016/0234191 A1
(43) Pub. Date: Aug. 11, 2016

(54) METHOD FOR TRANSMITTING AUTHENTICATION PASSWORD AND METHOD FOR ACQUIRING AUTHENTICATION PASSWORD BY MOBILE TERMINAL

(71) Applicant: Mei Kit LEONG, Hong Kong (CN)

(72) Inventors: Mei Kit LEONG, Hong Kong (CN); Ho Man Herman CHAN, Hong Kong (CN)

(73) Assignee: Mei Kit LEONG, Hong Kong (CN)

(21) Appl. No.: 14/895,308

(22) PCT Filed: Apr. 3, 2015
(86) PCT No.: PCT/CN2015/075826

§ 371 Date: Dec. 2, 2015

(30) Foreign Application Priority Data
Jul. 4, 2014 (CN) 201410318456.2

(51) Int. Cl. H04L 29/06

(52) U.S. Cl. CPC H04L 63/083; H04L 63/20; H04L 63/0428

(57) ABSTRACT

The present invention discloses a method for transmitting an authentication password by a mobile terminal, a method for acquiring an authentication password by an authentication server side, an authentication server side and a system, wherein the method for transmitting an authentication password by a mobile terminal comprises the following steps: an original authentication password is mapped according to a set rule into at least one of the following three: pixel values of certain pixel sets on said pictures or picture sequence, the displaying order of the pictures in the picture sequence, and the displaying interval between the pictures in the picture sequence; wherein, when said original authentication password is mapped to include the displaying order of each picture, each picture has different pixel characteristics; and said pictures or picture sequence is displayed on a display screen of said mobile terminal. The method and the system can improve the authentication security, and are applicable to intelligent mobile devices commonly used at present.

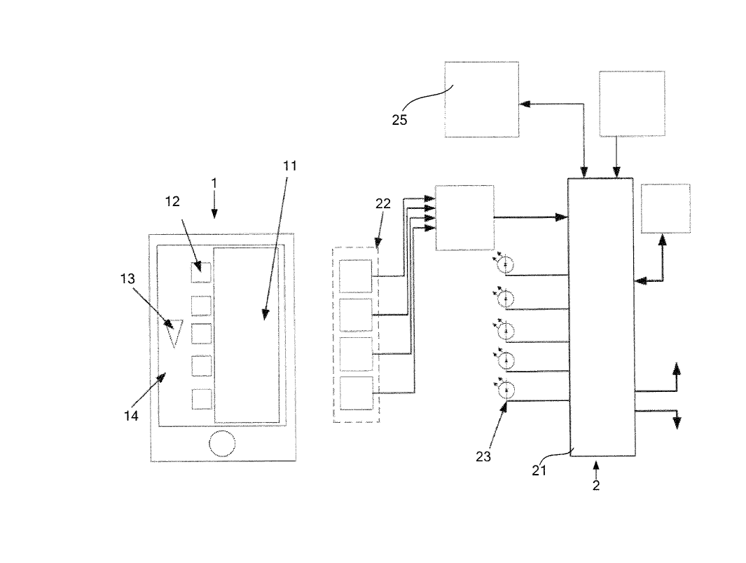

### TECHNICAL FIELD

The present invention relates to the field of communications, and particularly relates to a method for transmitting an authentication password by a mobile terminal, a method for acquiring an authentication password by an authentication server side, an authentication server side and an system.

### BACKGROUND ART

At present, intelligent terminals are widely used, and thus, methods for authenticating identity with the intelligent terminals are both convenient and reliable. However, generally the methods for authentication with the intelligent terminals are mainly carried out in a wireless manner, for example, by utilizing Bluetooth, NFC, WIFI, etc. As authentication password data are transmitted in a wireless manner, and in the communication process, these authentication password data are likely to be stolen and decoded by corresponding communication devices, therefore, the security is lacking in this manner.

In addition, there are many communication manners, such as NFC; before the popularity of an NFC technology, many old intelligent terminals do not support NFC communications, and merely after the popularity of the NFC technology, there are many intelligent terminals which have corresponding hardware apparatus to support the NFC, and therefore, to some degree, utilizing these wireless manners to carry out authentication obviously lacks popularization, and replacing intelligent terminals to support corresponding wireless manners is also unfavorable for environmental protection. Further, there exists a part of intelligent terminals which merely support one of the above-mentioned communication manners, such as WIFI, and when certain authentication needs Bluetooth, the intelligent terminals cannot carry out authentication.

### SUMMARY OF THE INVENTION

In order to overcome the deficiencies in the prior art, the present invention provides a method for transmitting an authentication password by a mobile terminal, a method for acquiring an authentication password by an authentication server side, an authentication server side and a system, which enable the authentication to be more convenient and secure.

The method for transmitting an authentication password by a mobile terminal comprises the following steps:

mapping an original authentication password according to a set rule into at least one of the following three: pixel values of certain pixel sets on said pictures or picture sequence, the displaying order of the pictures in the picture sequence, and the displaying interval between the pictures in the picture sequence; wherein, when said original authentication password is mapped to include the displaying order of each picture, each picture has different pixel characteristics;
and displaying said pictures or picture sequence on a display screen of said mobile terminal. A method for transmitting an authentication password by a mobile terminal comprises the following steps:
mapping an original authentication password into corresponding pictures or a picture sequence according to a set rule;
and displaying said pictures or picture sequence on a display screen of said mobile terminal.

In one embodiment, the method further comprises the following steps:

mapping a random sequence together into said pictures or picture sequence, wherein said random sequences comprise a first random sequence generated randomly by said mobile terminal and/or a second random sequence received by said mobile terminal and acquired by a user from an authentication server side;
after said original authentication password is encrypted by said random sequence according to a set algorithm, obtaining an authentication password;
and mapping the authentication password into corresponding pictures or picture sequence according to a set rule.

In one embodiment,

when said random sequence is a second random sequence received by said mobile terminal from an authentication terminal, or is formed by a first random sequence generated randomly by said mobile terminal and a second random sequence received by said mobile terminal and acquired by a user from an authentication server side, the method further comprises the following steps:
receiving the second random sequence input by the user in an input area of the mobile terminal by the mobile terminal successively,
wherein the input area of the mobile terminal and a second random sequence light-emitting area of the authentication server side are in one-to-one correspondence, and digital information represented by the light emitting of a certain sub-light-emitting area of said light-emitting area is the same as digital information represented by a certain corresponding sub-input area of said input area.

A method for acquiring an authentication password by an authentication server side comprises the following steps:

receiving pictures or a picture sequence sent from a mobile terminal by a light receiving module;
decoding at least one of the following three: pixel values of certain pixel sets on said pictures or picture sequence, the displaying order of the pictures in the picture sequence, and the interval between the pictures in the picture sequence into a read authentication password by the authentication server side according to a set rule;
comparing whether said read authentication password is the same as an original authentication password or not, if so, judging that the authentication of said mobile terminal passes, if not, judging that the authentication of said mobile terminal fails to pass.

A method for acquiring an authentication password by an authentication server side comprises the following steps:

receiving pictures or a picture sequence sent from a mobile terminal by a light receiving module;
decoding said pictures or picture sequence into a read authentication password according to a set rule;
comparing whether said read authentication password is the same as an original authentication password or not, if so, judging that the authentication of said mobile terminal passes, if not, judging that the authentication of said mobile terminal fails to pass.

In one embodiment,

at least one of the following three: pixel values of certain pixel sets on said pictures or picture sequence, the displaying order of the pictures in the picture sequence, and the interval between the pictures in the picture sequence is decoded into a read authentication password by the authentication server side according to a set rule.

In one embodiment, the method further comprises the following steps:

decoding said read authentication password and a first random sequence generated randomly by said mobile terminal from said pictures or picture sequence;
decoding an initially read authentication password according to said first random sequence, the read authentication password and a second random sequence stored by the authentication server side;
comparing whether the initially read authentication password is the same as the original authentication password or not, if so, judging that the authentication of said mobile terminal passes, if not, judging that the authentication of said mobile terminal fails to pass.

In one embodiment, when said random sequence is a second random sequence received by said mobile terminal from an authentication terminal, or is formed by a first random sequence generated randomly by said mobile terminal and a second random sequence received from an authentication server side, the method further comprises the following steps:

emitting light representing the second random sequence in a second random sequence light-emitting area by said authentication server successively;
wherein an input area of the mobile terminal and the second random sequence light-emitting area of the authentication server side are in one-to-one correspondence, and digital information represented by the light emitting of a certain sub-light-emitting area of said light-emitting area is the same as digital information represented by a certain corresponding sub-input area of said input area.

In one embodiment, after said authentication server side receives an instruction for cancellation of the original authentication password sent from a set server by a WIFI module, a new original authentication password is generated randomly by said authentication server side and stored, and said new original password is sent to a designated storage space by the WIFI module.

An authentication server side comprises a control unit, and further comprises a light receiving unit and a random sequence light-emitting area, said random sequence light-emitting area comprises multiple sub-light-emitting areas, and light emitted by each sub-light-emitting area represents different digital information;

said light receiving unit is used for receiving pictures or a picture sequence sent from a mobile terminal;
said control unit is used for decoding at least one of the following three: pixel values of certain pixel sets on said pictures or picture sequence, the displaying order of the pictures in the picture sequence, and the interval between the pictures in the picture sequence into a read authentication password according to a set rule, comparing whether said read authentication password is the same as an original authentication password or not, if so, judging that the authentication of said mobile terminal passes, if not, judging that the authentication of said mobile terminal fails to pass.

An authentication system comprises an authentication server side and a mobile terminal,

said mobile terminal comprises a mapping unit and a displaying unit:
said mapping unit is used for mapping an original authentication password into corresponding pictures or a picture sequence according to a set rule;
said displaying unit is used for displaying said pictures or picture sequence on a display screen of said mobile terminal;
said authentication server side comprises a control unit, a light receiving unit and a random sequence light-emitting area:
said random sequence light-emitting area comprises multiple sub-light-emitting areas, and light emitted by each sub-light-emitting area represents different digital information;
said light receiving unit is used for receiving the pictures or picture sequence sent from the mobile terminal;
and said control unit is used for decoding at least one of the following three: pixel values of certain pixel sets on said pictures or picture sequence, the displaying order of the pictures in the picture sequence, and the interval between the pictures in the picture sequence into a read authentication password according to a set rule, comparing whether said read authentication password is the same as an original authentication password or not, if so, judging that the authentication of said mobile terminal passes, if not, judging that the authentication of said mobile terminal fails to pass.

In one embodiment, the authentication system further comprises a WIFI module for use: after said authentication server side receives an instruction for cancellation of the original authentication password sent from a set server by the WIFI module, a new original authentication password is generated randomly by said authentication server side and stored, and said new original password is sent to a designated storage space by the WIFI module.

The mobile terminal can be a mobile terminal, such as a smartphone and a tablet computer.

A series of continually varying color animation pictures can be generated, and coordinated with the selection or combination of different colors on different pixel points of each picture, the playing order of the pictures and the time interval between the pictures, the possibilities of a large amount of combined encoding can be generated, thus making the difficulty of decoding very high. In addition, the original authentication password is encrypted by two groups of random sequences generated by the mobile terminal and the authentication server side, so that the security of authentication is further improved. The method and the system have relatively low requirements for hardware, which can be widely applicable to the intelligent mobile devices commonly used at present, thus contributing to the improvement the wide use of the method and the system.

### DESCRIPTION OF THE DRAWINGS

The FIGURE is a schematic diagram of an authentication system according to an embodiment of the present invention.

### DETAILED DESCRIPTION OF THE INVENTION

The preferred embodiments of the present invention will be described in further details below.

As shown in the FIGURE, an authentication system of an embodiment comprises a mobile terminal 1 and an authentication server side 2, wherein the mobile terminal comprises a mapping unit and a displaying unit 14, the displaying unit 14 comprises a picture displaying area 11, an input area 12 and a picture displaying key area 13, and said mapping unit is used for mapping an original authentication password into corresponding pictures or a picture sequence according to a set rule; and the authentication server side 2 comprises a control unit 21, a light receiving unit 22 and a second random sequence light-emitting area 23, the mobile terminal can have a touch control display screen, the input area 12 comprises multiple sub-input areas, and the second random sequence light-emitting area 23 comprises multiple sub-light-emitting areas.

The mobile terminal stores the original authentication password, and the original authentication password can be generated randomly by the mobile terminal or set by a user through an input interface.

S1. Then the original authentication password needs to be sent to the authentication server side 2 for storage. The authentication server side 2 initiates a process of receiving the original authentication password. The authentication server side 2 randomly generates a second random sequence, and the second random sequence is transmitted to the mobile terminal 1 through the light emitting of each sub-light-emitting area of a second random sequence light-emitting area 23, the light emitted by different sub-light-emitting areas represents different digital codes, for example, the light emitting of a first sub-light-emitting area of the second random sequence light-emitting area 23 represents a first number, and the light emitting of a second sub-light-emitting area represents a second number, and so on. When the authentication server side 2 begins to send the second random sequence, the mobile terminal 1 also needs to enter a state of receiving the second random sequence, and the displaying unit 14 has displayed the input area 12, the input area 12 and the second random sequence light-emitting area 23 are in one-to-one correspondence, and digital information represented by the light emitting of a certain sub-light-emitting area is the same as digital information represented by a certain corresponding sub-input area of the input area 11, for example, the first sub-light-emitting area represents a number 1, then, the first sub-input area also represents the number 1, and after a user operates in the first sub-input area, the mobile terminal 1 determines to have received the number 1 from the input area 12. The authentication server side 2 successively transmits each digital code of the second random sequence through the sub-light-emitting areas, and the user successively operates in the corresponding sub-input areas, thus the mobile terminal 1 can receive the second random sequence completely.

S2. The user performs the corresponding operation on the mobile terminal 1 (for example, operations may be performed in the picture playing key area 13), and the mobile terminal 1 can learn that the reception of the second random sequence is finished. The mobile terminal 1 acquires an authentication password by encrypting said original authentication password with the second random sequence received by the mobile terminal 1 and the first random sequence randomly generated by itself according to a set algorithm. Naturally, it is also possible to encrypt the original authentication password with only one group of random sequence or not to encrypt the original password according to said algorithm, but the encryption effect may be relatively poor.

S3. Then, the mobile terminal 1 maps the authentication password and the first random sequence into corresponding pictures or picture sequence according to a set rule.

In one embodiment, each digital code in the authentication password and the first random sequence is mapped into a pixel value on a corresponding pixel point of a certain picture. For example, a number 1 is mapped to a certain pixel value of a first pixel in a first row of the picture, and a number 2 is mapped to a certain pixel value of a second pixel in a second row of the picture, and so on. Or, each digital code may be mapped into a pixel value of a corresponding pixel area of a certain picture, while the pixel value of the pixel area shows a certain color to the outside on a macro level, and thus in this case, this digital code corresponds to a certain color, that is to say, the authentication password may be shown as different color areas of different parts of a certain picture.

In another embodiment, each digital code in the authentication password and the first random sequence is mapped as a pixel value on a corresponding pixel point of multiple pictures on a group of picture sequence. According to the analysis of the previous embodiment, it can be known that the authentication password may be mapped into different colors of different areas of multiple pictures.

In another embodiment, each digital code in the authentication password and the first random sequence is mapped into the displaying order of multiple pictures of a group of picture sequence, for example, the picture sequence has 5 pictures numbered successively, and the order of the picture sequence: picture 1, picture 2, picture 3, picture 4 and picture 5 represent that the authentication password is 12345. In order to differentiate each picture in the picture sequence, each picture has different pixel characteristics, for example, in the same area of each picture, the pixel distribution of the picture 1 and the picture 2 is different, and thus authentication server side can judge different pictures by analyzing the pixel distribution of the same area when identifying.

In another embodiment, each digital code in the authentication password and the first random sequence is mapped into the displaying interval between the pictures of a group of picture sequence, for example, 5 ms represents a number 5, 7 ms represents a number 7, etc. In this case, adjacent pictures may have different pixel characteristics, and may also have the same pixel characteristics.

In another embodiment, the authentication password and the first random sequence may be mapped into: two or more of pixel values of certain pixel sets on said pictures or picture sequence, the displaying order of the pictures in the picture sequence and the displaying interval between the pictures in the picture sequence, therefore the information that can be used for encoding is more, and the difficulty in decoding is higher.

S4. Then, a user operates in the picture playing key area 13. Said pictures or picture sequence is displayed by the mobile terminal 1 through the picture displaying area 11, and the displayed contents are received by the light receiving unit 22 of the authentication server side 2. In order to achieve better receiving effect, then preferably, the picture displaying area is aligned with the light receiving unit 22. When the time interval of the picture sequence is less than a certain threshold, the picture sequence is continuous animations in people's eyes and more digital information can be carried.

S5. The authentication server side 2 receives the pictures or picture sequence by the light receiving unit 22, and then the light receiving unit may decode to acquire the authentication password and the first random sequence by acquiring pixel values of certain pixels according to the set rule described above.

When the authentication password is mapped into a pixel value of a corresponding pixel area of a certain picture, since the pixel value of the pixel area shows a certain color to the outside on a macro level, multiple photosensitive diodes sensitive to different colors can be disposed at a light receiving end, for example, each sub-receiving unit comprises three kinds of photosensitive diodes of red, green and blue, and corresponding color received by each photosensitive diode represents 1, otherwise represents 0, while the colors of the picture areas corresponding to the first sub-receiving unit, the second sub-receiving unit and the third sub-receiving unit respectively are red, green and blue respectively, and then, 100, 010 and 001 are received by the three sub-light receiving units successively.

When the authentication password is mapped into the displaying order of multiple pictures, the pixel characteristics of each picture are judged by the light receiving unit respectively to obtain the order of the pictures and then the authentication password corresponding to the order.

When the authentication password is mapped into the displaying interval between the pictures of a group of picture sequence, and received by the light receiving unit, for example, adjacent pictures have the same or different pixel characteristics, then the light receiving unit can decode to obtain a corresponding authentication password according to the above-mentioned mapping relation after the identified pixel characteristics of the previous picture disappear and before the pixel characteristics of the next picture are identified, and such time interval is the time interval of adjacent pictures.

S6. The obtained authentication password is decrypted by the authentication server side 2 based on the first random sequence and the second random sequence stored by the authentication server side 2 according to a set algorithm to acquire the original password and store the original password, thus completing the original authentication password setting by the authentication server side 2. If in step S1, the second random sequence input by the user in the input area 12 of the mobile terminal 1 is incorrect, the authentication server side 2 cannot correctly obtain the original password. The process for certification by the mobile terminal on the authentication server side 2 is as follows:

T1. the same as the method of step S1, wherein the second random sequence is generated randomly by the authentication server side 2, the user inputs a corresponding number sequence in the input area 12 in the mobile terminal 1 successively according to the light emitting of the second random sequence light-emitting area 22 of the authentication server side 2, and thus the second random sequence obtained by receiving is acquired by the mobile terminal 1;

T2. the same as the method of step S2, wherein the mobile terminal 1 acquires an authentication password by encrypting said original authentication password with the second random sequence received by the mobile terminal 1 and the first random sequence randomly generated by itself according to a set algorithm.

S3. the same as the method of step S3, wherein the authentication password and the first random sequence are mapped into corresponding pictures or picture sequence by the mobile terminal 1 according to a set rule.

T4. the same as the method of step S4, wherein the pictures or picture sequence is showed by the mobile terminal 1 through a picture showing area 11, and the shown contents are received by the light receiving unit 22 of the authentication server side 2.

T5. the same as the method of step S4, wherein the authentication server side 2 receives the pictures or picture sequence by a light receiving unit 22 and decodes to obtain the authentication password and the first random sequence according to the above-mentioned set rule.

T6. the same as the method of step S4, wherein the authentication server side 2 decodes the obtained authentication password to obtain the original authentication password according to a set algorithm based on the first random sequence and the second random sequence stored by the authentication server side 2.

T7. The obtained original password is compared with the original authentication password stored by the authentication server side, if both are the same, it will be judged that the authentication of the mobile terminal passes, and the information of successful authentication can be sent, otherwise it will be judged that the authentication of the mobile terminal fails to pass, and the information of unsuccessful authentication can be sent. The reason for authentication failure may include that the user inputs the incorrect second random sequence in the input area 12 of the mobile terminal, or the original authentication password stored by the mobile terminal is not the same as the valid original authentication password.

In one embodiment, the authentication server side 2 may further comprise a WIFI module 25. When the user's mobile terminal 1 is lost and the user logs in a certain set server, the server sends an instruction for cancellation of the password to the WIFI module 25, the WIFI module 25 sends a corresponding instruction for cancellation of the password to the control unit 21, the control unit 21 generates randomly and stores a new original authentication password, to replace the previously stored original authentication password, and then the control unit 21 sends the new original password to a designated storage space through the WIFI module 25, for example, a certain server or a certain E-mail address and the like, thereby effectively preventing illegal users from using the lost mobile terminal to authenticate. In order to ensure security, the WIFI module 25 can only send the instruction for cancellation of the password to the control unit 21, and cannot write in the new original password through the control unit 21.

In one embodiment, the input area 12 is not limited to a partial area of a touch display screen, and may be fixed mechanical keys, or may adopt other input modes.

The above content is further detailed description made for the present invention in connection with specific preferred embodiments. It should not be considered that the specific embodiments of the present invention are limited to these descriptions. To those ordinarily skilled in the art to which the present invention belongs, some simple deductions or replacements may also be made without departing from the inventive concept, which all should be considered as belonging to the scope of patent protection determined by the submitted claims.

1. A method for transmitting an authentication password by a mobile terminal, characterized by comprising the following steps:
mapping an original authentication password according to a set rule into at least one of the following three: pixel values of certain pixel sets on said pictures or picture sequence, the displaying order of the pictures in the picture sequence, and the displaying interval between the pictures in the picture sequence; wherein, when said original authentication password is mapped to include the displaying order of each picture, each picture has different pixel characteristics;
and displaying said pictures or picture sequence on a display screen of said mobile terminal.

2. The method for transmitting an authentication password by a mobile terminal of claim 1, characterized by further comprising the following steps:
mapping a random sequence together into said pictures or picture sequence, wherein said random sequence comprises a first random sequence generated randomly by said mobile terminal and/or a second random sequence received by said mobile terminal and acquired by a user from an authentication server side;
after said original authentication password is encrypted by said random sequence according to a set algorithm, obtaining an authentication password;
and mapping the authentication password into corresponding pictures or picture sequence according to a set rule.

3. The method for transmitting an authentication password by a mobile terminal of claim 2, characterized in that, when said random sequence is a second random sequence received by said mobile terminal from an authentication terminal, or is formed by a first random sequence generated randomly by said mobile terminal and a second random sequence received by said mobile terminal and acquired by a user from an authentication server side, further comprising the following steps:
receiving a second random sequence input by a user in an input area of the mobile terminal successively by the mobile terminal,
wherein, the input area of the mobile terminal and a second random sequence light-emitting area of the authentication server side are in one-to-one correspondence, and digital information represented by the light emitting of a certain sub-light-emitting area of said light-emitting area is the same as digital information represented by a certain corresponding sub-input area of said input area.

4. A method for acquiring an authentication password by an authentication server side, characterized by comprising the following steps:
receiving pictures or a picture sequence sent from a mobile terminal by a light receiving module;
decoding at least one of the following three: pixel values of certain pixel sets on said pictures or picture sequence, the displaying order of the pictures in the picture sequence, and the interval between the pictures in the picture sequence into a read authentication password by the authentication server side according to a set rule;
comparing whether said read authentication password is the same as an original authentication password or not, if so, judging that the authentication of said mobile terminal passes, if not, judging that the authentication of said mobile terminal fails to pass.

5. The method for acquiring an authentication password by an authentication server side of claim 4, characterized by further comprising the following steps:
decoding said read authentication password and a first random sequence generated randomly by said mobile terminal from said pictures or picture sequence;
decoding a decoded authentication password according to said first random sequence, the read authentication password and a second random sequence stored by the authentication server side;
comparing whether the decoded authentication password is the same as the original authentication password or not, if so, judging that the authentication of said mobile terminal passes, if not, judging that the authentication of said mobile terminal fails to pass.

6. The method for acquiring an authentication password by an authentication server side of claim 5, characterized in that, when said random sequence is the second random sequence received by said mobile terminal from an authentication terminal, or is formed by the first random sequence generated randomly by said mobile terminal and the second random sequence received from the second authentication server side, further comprising the following steps:
emitting light representing the second random sequence successively by said authentication server side in a second random sequence light-emitting area;
wherein, an input area of the mobile terminal and the second random sequence light-emitting area of the authentication server side are in one-to-one correspondence, and digital information represented by the light emitting of a certain sub-light-emitting area of said light-emitting area is the same as digital information represented by a certain corresponding sub-input area of said input area.

7. The method for acquiring an authentication password by an authentication server side of claim 5, characterized in that,
after said authentication server side receives an instruction for cancellation of the original authentication password sent from a set server by a WIFI module, a new original authentication password is generated randomly by said authentication server side and stored, and said new original password is sent to a designated storage space by the WIFI module.

8. An authentication server side, comprising a control unit, characterized by further comprising a light receiving unit and a random sequence light-emitting area, said random sequence light-emitting area comprising multiple sub-light-emitting areas, and light emitted by each sub-light-emitting area representing different digital information;
said light receiving unit being used for receiving pictures or a picture sequence sent from a mobile terminal;
said control unit being used for decoding at least one of the following three: pixel values of certain pixel sets on said pictures or picture sequence, the displaying order of the pictures in the picture sequence, and the interval between the pictures in the picture sequence into a read authentication password according to a set rule, comparing whether said read authentication password is the same as an original authentication password or not, if so, judging that the authentication of said mobile terminal passes, if not, judging that the authentication of said mobile terminal fails to pass.

9. An authentication system, comprising an authentication server side and a mobile terminal, characterized in that:
said mobile terminal comprises a mapping unit and a displaying unit:
said mapping unit is used for mapping an original authentication password into corresponding pictures or a picture sequence according to a set rule;
said displaying unit is used for displaying said pictures or picture sequence on a display screen of said mobile terminal;
said authentication server side comprises a control unit, a light receiving unit and a random sequence light-emitting area:
said random sequence light-emitting area comprises multiple sub-light-emitting areas, and light emitted by each sub-light-emitting area represents different digital information;
said light receiving unit is used for receiving the pictures or picture sequence sent from the mobile terminal;
and said control unit is used for decoding at least one of the following three: pixel values of certain pixel sets on said pictures or picture sequence, the displaying order of the pictures in the picture sequence, and the interval between the pictures in the picture sequence into a read authentication password according to a set rule, comparing whether said read authentication password is the same as an original authentication password or not, if so, judging that the authentication of said mobile terminal passes, if not, judging that the authentication of said mobile terminal fails to pass.

10. The authentication system of claim 9, characterized by further comprising a WIFI module for use: after said authentication server side receives an instruction for cancellation of the original authentication password sent from a set server by the WIFI module, a new original authentication password is generated randomly by said authentication server side and stored, and said new original password is sent to a designated storage space by the WIFI module.
